(19) United States
(12) Patent Application Publication
(10) Pub. No.: US 2010/0187969 A1
(43) Pub. Date: Jul. 29, 2010

(54) LUMINOUS BODY FOR AN INCANDESCENT LAMP AND METHOD FOR ITS PRODUCTION

(76) Inventors: Axel Bunk, Munchen (DE); Christa Bunk, Munchen (DE); Stefan Oskar Axel Bunk, Munchen (DE); Maximillian Rasso Herbert Bunk, Munchen (DE); Ludwig Johannes Christian Bunk, Munchen (DE); Matthias Damm, Gaimersheim (DE); Georg Rosenbauer, Wassertrudingen (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,441

(22) PCT Filed: Jul. 20, 2007
(86) PCT No.: PCT/EP2007/057534

§ 371 Date: Feb. 9, 2010

(30) Foreign Application Priority Data
Jul. 28, 2006 (DE) 10 2006 035 116.9

(51) Int. Cl. H01K 1/00; H01J 1/15; H01K 1/42

(52) U.S. Cl. 313/315; 313/341; 445/35

(57) ABSTRACT

Luminous body for an incandescent lamp and method for producing such a luminous body. A wire for a luminous body is used whose diameter increases from the outside in. The production method is based either on a deposition method or a metal-removal method.

### TECHNICAL FIELD

The invention is based on a luminous element in accordance with the preamble of claim 1. Such luminous elements are used for general lighting and for photooptical purposes. Furthermore, the invention describes an associated manufacturing process.

### PRIOR ART

The life of lamps in which the generation of light is based on the principle of incandescent emission is usually determined by the evaporation or decomposition of the luminous element material.

Thus, the life of lamps with incandescent elements consisting of tungsten (i.e. incandescent lamps or incandescent halogen lamps) is usually determined by the evaporation of the tungsten. In addition, there is also a large number of further failure mechanisms, for example filament end corrosion by chemical attack of a halogen additive on the colder filament end, fusing of the filament after the production of an arc, failure of the filament owing to sliding grain boundaries, etc. However, these mechanisms usually only play a role in individual lamp types (for example the formation of an arc is the primary cause of failure in a few lamp types which are subjected to particularly high loads) or in faulty lamps (for example lamps with an increased oxygen impurity level). Most incandescent lamps are designed and/or operated such that the end of life is ultimately determined by the tungsten evaporation. The vaporized tungsten is transported in the direction of the bulb wall.

The situation is similar for lamps with luminous elements consisting of metal carbide. Lamps with luminous elements consisting of tantalum carbide have the advantage that they can be operated at temperatures which are approximately 500 K higher than lamps with luminous elements consisting of tungsten. However, at relatively high temperatures rapid decomposition of the tantalum carbide takes place in accordance with 2 TaC <s>−> Ta₂C <s>+C <g>, with the brittle tantalum subcarbide which melts at relatively low temperatures being produced, cf., for example, Becker/Ewest. “Die physikalischen and strahlungstechnischen Eigenschaften des Tantalcarbids” [The physical and radiation-related properties of tantalum carbide], Zeitschrift fur technische Physik [Journal of Technical Physics], No. 6, page 216 et seq. (1930). The gaseous carbon produced in this decarburization reaction is transported in the direction of the bulb wall.

In order to avoid the deposition of the materials vaporized off from the luminous element—i.e., for example, of tungsten in the case of lamps with an incandescent element consisting of tungsten and carbon in the case of lamps with an incandescent element consisting of carbon or metal carbides—on the bulb wall, so-called cyclic processes are used. Examples of this are:

(a) Tungsten/Halogen Cyclic Process

The tungsten vaporizing off from the luminous element combines at relatively low temperatures close to the bulb wall to form tungsten halides, which tungsten halides are volatile at temperatures above approximately 200° C. and are not deposited on the bulb wall. As a result, the failure of tungsten on the bulb wall is prevented. The tungsten halide compounds are transported back by means of diffusion and possibly also convection to the hot luminous element, where they decompose. The tungsten which has been released in the process is again deposited on the luminous element. There is extensive literature relating to the halogen cyclic process in halogen lamps with an incandescent element consisting of tungsten. As regards properties of diverse halogen cyclic processes in halogen lamps, see, for example, “Optische Strahlungsquellen” [Optical radiation sources], Chapter 4 “Halogen-Glühlampen” [Incandescent halogen lamps], Lexika Verlag, 1977 and the literature cited therein.

(b) Carbon/Hydrogen Cyclic Process in TaC Lamps

The gaseous carbon produced during the decomposition of the TaC is transported in the direction of the bulb wall, where it reacts with hydrogen to give hydrocarbons such as methane. These hydrocarbons are transported back to the hot luminous element, where they decompose again. The carbon is in this case released again and can be deposited on the luminous element, cf., for example, U.S. Pat. No. 2,596,469, U.S. Pat. No. 3,022,438.

The evaporation of a material of the luminous element, i.e., for example, the vaporization of tungsten in the case of a lamp with a luminous element consisting of tungsten or the vaporization of carbon from a lamp with a luminous element consisting of metal carbide, does not take place homogeneously over the entire luminous element. Instead, locally limited points are produced at which increased vaporization takes place and at which the luminous element ultimately also fails. The failure mechanism can be described at least in principle by the “hot-spot model”, as is illustrated for lamps with a tungsten filament, for example, in H. Hörster, E. Kauer, W. Lechner, “Zur Lebensdauer von Glühlampen” [The life of incandescent lamps], Philips techn.

Rdsch. 32, 165-175 (1971/72). Owing to a small “fault” along the luminous element wire, for example as a result of an increased power input at a grain boundary, a low local change in the material data, a locally limited reduction in the wire diameter, a local impurity in the luminous wire, an excessively small gap between two turns when using filaments etc., a slight locally limited heating of a point with respect to the surrounding environment takes place (local limiting to a maximum of two turns). The local increase in the temperature means that material vaporizes off to an increased extent from this point and this point is therefore preferably tapered with respect to the surrounding environment, as a result of which the resistance at this point increases. Since the increase in the resistance is limited to a small region, the total resistance of the luminous element is virtually unchanged thereby or is only increased by a considerably smaller fraction than the resistance at the point under consideration. At the narrowly limited point with increased resistance there is an increased power input since the same or only a comparatively slightly lower current flows through this point which now has an increased resistance. As a result, the temperature is further increased, which in turn accelerates the tapering of this point with respect to the surrounding environment etc. In the described way, the formation of a thin point itself is accelerated and ultimately results in the luminous wire burning through at this point. In the case of lamps consisting of metal carbides such as tantalum carbide, a further effect in comparison with incandescent elements consisting of tungsten also occurs in which the subcarbide Ta₂C produced during the evaporation of carbon has an electrical resistivity which is higher than TaC by a factor of more than 3, cf., for example, S. Okoli, R. Haubner, B. Lux, “Carburization of tungsten and tantalum filaments during low pressure diamond deposition”, Surface and Coatings Technology, 47 (1991), 585-599. This influence means that the destructive mechanism in the case of luminous elements consisting of tantalum carbide builds up even more rapidly than in the case of luminous elements consisting of tungsten.

One option for avoiding or suppressing the abovedescribed fault mechanism now consists in transporting the material which has vaporized off from the luminous element back to the hottest point on the luminous element in a targeted manner by the use of suitable cyclic processes; this is then referred to as so-called “regenerative cyclic processes”.

The cyclic processes used nowadays in halogen lamps with incandescent filaments consisting of tungsten which use bromine or iodine as the active halogen components are not regenerative since tungsten/bromine or tungsten/iodine compounds already decompose at temperatures far below 2000 K. The tungsten is therefore usually already deposited at points with a low temperature and deposited unspecifically on the luminous element; in any case not transported selectively back to the locations with the highest temperature. The cyclic process therefore does not have a life-extending effect. In order to achieve a regenerative cyclic process, chemical reaction systems are required in which the increase in the vaporization rate of the tungsten with increasing temperature is compensated or readily overcompensated for by the increase in the deposition rate of tungsten after the decomposition of tungsten compounds in the temperature range in question usually above 2800 K. For lamps with incandescent filaments consisting of tungsten, the tungsten/fluorine system represents a suitable chemical reaction system, cf., for example, Schröder, PHILIPS Techn. Rundschau 1963/64, page 359. In the thermal decomposition of tungsten/fluorine compounds, tungsten is released or deposited first at temperatures of between 2000 K and 3500 K, depending on the dose of fluorine or the presence of further components. The chemical reactivity of fluorine or fluorine-containing compounds stands in the way of the use of fluorine, however; for example fluorine reacts at the bulb wall consisting of glass to form SiF₄ and is therefore withdrawn from the cyclic process. Protection of the glass bulb, for example by means of coating it with AlF₃, Al₂O₃ (which forms a passivating AlF₃ layer by reaction with fluorine), or the use of fluorine-inert materials is therefore required. These measures result in the lamp being considerably more expensive.

The abovementioned carbon/hydrogen cyclic process which is sometimes used in the case of lamps with a luminous element consisting of metal carbides is not regenerative since the carbon/hydrogen compounds usually already virtually completely decompose at temperatures below 1000 K.

If there is no regenerative cyclic process for eliminating hot spots or such a process cannot be used for cost reasons, it is possible to attempt to use other measures in order to increase the life for a given luminous efficiency. For example, the vapor pressure of the luminous element material can be reduced (cf., for example, DE 10 2005 057 084.4 for lamps with a luminous element consisting of metal carbide); or the luminous element can be stabilized in a continuous flow of that material which is vaporized by it (cf., for example, DE 10 2005 052 044.5), etc. All of the measures which are well known in the art and which slow down the transport of the material vaporizing off from the luminous element, i.e., for example, an increase in the filling pressure, the use of inert gases which are as heavy as possible, the use of constructions which reduce the conduction of heat, result in an at least moderate increase in the life given a constant luminous efficiency even in the absence of a regenerative cyclic process. Smoothing of the temperature profile of the filament by modulation of the filament pitch given a constant wire diameter as described, for example, in DE-U 83 12 136 likewise contributes to the increase in the life. Alternatively, the temperature profile along the filament can also be influenced by a combination of filaments with different properties in accordance with DD 247 769 A1.

Further details are given below on the option of smoothing the temperature profile by varying the cross section of the filament wire and thereby increasing the life for a given luminous efficiency.

The consideration below is based on the observation that, in the case of lamps in which the light emission is based on the principle of incandescent emission, the formation of a temperature profile along the luminous element arises during lamp operation. Heat is dissipated via the power supply lines, which results in the temperatures at locations close to the power supply lines being markedly below those in the center between the power supply lines. In addition, the transport of radiation within the filament plays an important role. In this case, the radiation emitted by a turn of the filament inwards is absorbed at least partially by the inner sides of other turns. The non-absorbed part of the radiation is reflected. The smaller the gap between the inner sides of two turns is, the greater the transport of radiation between them since the radiation-receiving surface “shades” a greater solid angle around the emitting surface. This results immediately in the transport of radiation also resulting in a temperature profile being formed along the filament which has its maximum in the filament center, since the sum of all the gaps between one turn and the other turns is minimal for the turn in the filament center. In addition, a high level of radiation transport takes place between the lateral surfaces of directly adjacent turns.

In lamps with coiled incandescent filaments, the location with the highest temperature is therefore usually located close to the filament center, while the temperatures close to the filament ends are markedly lower. The thicker or shorter the luminous wire, the steeper the temperature profile along the filament generally is, i.e. the greater the temperature differences between the filament center and the filament ends. The temperature profile along the filament has an important influence on the transport rates. In this connection, it has proven successful to distinguish between radial and axial transport rates, as is illustrated, for example, in H. Hörster, E. Kauer, W. Lechner, “Zur Lebensdauer von Glühlampen” [The life of incandescent lamps], Philips techn. Rdsch. 32, 165-175 (1971/72). The radial transport describes the transport of the material vaporizing off from the luminous element in the direction of the bulb wall. Inter alia, it is proportional to the vaporization rate of the material from the luminous element. If, as is the practice in most cases, it can be assumed that the equilibrium vapor pressure is set at the surface of the luminous element, the transport rate for the radial transport is proportional to the equilibrium vapor pressure at the surface of the luminous element. The rate for the axial transport is proportional to the gradient of the vaporization rates of the material along the filament axis or, in the abovedescribed approximation which can generally be used, to the gradient of the equilibrium pressures along the filament axis. The steeper the temperature profile along the filament axis, the greater the gradients for the equilibrium pressures; and the greater the rates for the axial transport.

As a result of modulation of the wire thickness, leveling off of the temperature profile along the filament can be achieved. By way of explanation, first the influence of the wire diameter on the wire temperature is therefore taken into consideration. If, for example, a slight thickening of the wire is provided in the filament center, a reduction in the temperature in the center of the luminous element with the current initially being assumed to be constant is achieved, which can be attributed substantially to the reduced power input at this point as a result of the lower electrical resistance, but also as a result of other effects such as increased cooling owing to a larger emitting area. The reverse is true in the case of a reduction in the wire diameter. If, therefore, it were desired to smooth the temperature profile along the filament axis, less power would need to be input or more power dissipated in the filament center than at the filament ends.

This can be achieved by virtue of the fact that the diameter of the filament wire is designed to be greater in the filament center than at the filament ends. Then, owing to the lower electrical resistance in the filament center, less power is input than at the filament ends, which has the effect of flattening off the temperature profile.

Essential as regards the influence on the life is the sum of the axial and radial transport, which assumes a maximum at a point along the luminous element. This maximum of the material removal determines the life. The aim of the modulation of the wire thickness overall is to minimize the maximum of the sum of the axial and radial transport which determines the life of the lamp. In this sense, a temperature distribution which is entirely homogeneous over the luminous element and falls away steeply at the filament ends is not ideal. In this case, the axial transport in the coil would be equal to zero, but a very high level of transport along the power supply lines would be obtained at the filament ends, and this would also be superimposed by a very high level of radial transport. The filament would then fail rapidly at the filament ends or power supply lines. It is better to design the temperature drop in the case of high temperatures in the coil such that the sum of the radial and axial transport changes as little as possible. In general, in such a case the axial transport will increase toward the filament ends, but this can be compensated for by a decrease in the radial transport as the temperature drops.

One option for varying the cross section of the luminous wire in a desired manner consists in removing material by means of electrolytic removal in the region of the luminous element close to the power supply lines, as described in DD 217 084 A1.

A further option consists in removing tungsten in relatively cold regions and depositing it again in relatively hot regions by the use of a transport medium, as described in J. Schröder, “Profilierung von Wolframwendeln in Glühlampen durch chemische Transportreaktionen” [Profiling of tungsten filaments in incandescent lamps by chemical transport reactions], Philips techn. Rdsch. 35, 354-355 (1975/76). For example, by operation of the incandescent filament in an atmosphere consisting of an inert gas and fluorine, tungsten can be removed at relatively cold points and redeposited at relatively hot points, which results in smoothing of the temperature profile. Owing to the measures described below, an extension of the life given a constant luminous efficiency in the absence of a regenerative cyclic process can be achieved by the transport rates along the filament being reduced by modulation of the cross section of the luminous element.

### DESCRIPTION OF THE INVENTION

The object of the present invention is to increase the life in the case of a luminous element of the generic type and to specify a process for the manufacture thereof.

This object is achieved by characterizing features of claim 1. Particularly advantageous configurations are given in the dependent claims. An essential feature of the invention is to vary the cross section of the luminous element by a deposition or material removal process, which generally takes place continuously, which results in substantial advantages over the electrolytic removal process described in DD 217 084 A1 and over the material redeposition process described in Philips techn. Rdsch. 35, 354-355 (1975/76), details of which will be given further below.

In order to set a temperature profile which is as flat as possible over the region of the filament in a targeted manner, it is proposed to use a suitable back-reaction of known cyclic processes. For this purpose, the filament is brought, by the application of a suitable voltage, into such a temperature range that the chemical compound transporting the filament material almost completely decomposes at the highest temperatures close to the filament center. This means that, during operation of the incandescent filament, the greatest growth in the wire thickness is obtained as a result of deposition close to the hot filament center in a gas flow which, inter alia, contains the chemical component in question, while the increase in the wire thickness is comparatively small close to the filament ends. This amounts to a self-regulating system, at least over the temperature interval in which the deposition rates change to a considerable extent with the temperature. The increased deposition in the lamp center results in the luminous element temperature being cooled to a greater extent there than at the locations close to the filament ends, which in turn means that the difference in the deposition rates is reduced as the temperature difference between the filament center and the filament ends is reduced. The system thus functions in self-regulating fashion, i.e. the difference in the deposition rates between the filament center and the filament ends means that the temperature profile flattens off, which in turn results in a reduction in the difference in the deposition rates. The difference in the deposition rates along the filament disappears ideally only when the temperature differences between the filament ends and the filament center are completely balanced out. After a complete adjustment, the deposition rates along the luminous element are therefore equal in size. “Overcontrol”, i.e. the setting of lower temperatures in the filament center in comparison with the surrounding environment, is therefore not possible. It should be noted that a chemical reaction system only results in different deposition rates over a restricted temperature interval. If, for example, the luminous element is operated in such a way that a region is at such a high temperature that the component bearing the luminous element material has completely decomposed, the same deposition rates are obtained over this temperature range, i.e. any temperature differences are no longer balanced out. Incidentally, the relevant regions of the incandescent element should not be at such a low temperature that barely any deposition takes place.

This deposition, controlled via the temperature, of luminous element material for modulating the wire thickness can be considered to be a partial reaction of a regenerative cyclic process since the deposition preferably takes place at points with a relatively high temperature. In contrast to the finished lamp, however, in this process step the filament is brought into such a temperature range, which is generally not suitable for light generation, in which the deposition rates change along the filament. The described modulation is carried out during the manufacture of the lamp; for this purpose, the filament, which is possibly already fixed in a rod-shaped lamp, is operated in a gas flow. The modulation can also take place at the filament which has been completely wound prior to the fixing of the filament in a glass bulb. Typically, suitable wire thickness profiles can be set within a few minutes; see the exemplary embodiment described below. Only then is the construction of the lamp completed, i.e. the filament is fixed in the lamp and pinch-sealed if the modulation was carried out directly at the filament, or the lamp is filled with a filling gas and fused off. The deposition reactions can also be considered to be CVD processes (CVD=Chemical Vapor Deposition).

For the described reasons, the filament needs to be operated in such a temperature range that the deposition rates change markedly over the temperatures occurring along the filament. The suitable temperature range is in this case largely fixed by the chemistry of the chemical reaction system used. It is most favorable to use, for leveling off the filament temperature profile along the filament, such a chemical reaction system for which the temperature during the deposition corresponds as far as possible to that during lamp operation. Owing to the different weight of individual terms in the energy balance, the filament temperature profiles for various applied voltages or therefore various maximum filament temperatures cannot be transferred by simple linear transformation into one another. Thus, the heat dissipation along the luminous element and the heat dissipation in the radial direction via the filling gas toward the bulb at relatively low temperatures plays, in relative terms, a much more important role than in the case of typical operating temperatures of the luminous element. As the temperature increases, the radiation becomes ever more important corresponding to the laws of radiation. This means that, as the temperature decreases, firstly the regions with temperature changes close to the filament ends expand to an ever greater extent since the conduction of heat along the luminous element wire plays an ever greater role, i.e. increasingly expanded temperature profiles close to the filament ends are obtained as the temperature decreases. Secondly, as the temperature decreases the temperature profile around the filament center flattens off increasingly since the transport of radiation plays an ever lesser role.

During the deposition, the wire thickness increases at each location, even if it is to a different degree, with the result that there is a reduction in the temperature as the deposition time increases. Since the rate of the deposition reaction becomes ever smaller as the temperature decreases or in relatively cold regions virtually no deposition takes place any more, it is recommended to keep the incandescent filament, through readjustment (increasing) of the voltage, in such a temperature range that corresponds to the “adjustment range” of the chemical reaction system. This readjustment of the voltage is optimally controlled by a measurement of the temperature of the incandescent filament. By way of approximation, a power-controlled readjustment can also take place. Since the power consumption increases with increasing wire thickness given a constant filament temperature, it is recommended in this case to switch off the applied voltage for a short period of time in order to measure the change in the cold resistance, which can be attributed to the change in the wire diameter, and then to correspondingly readjust the power.

The described leveling off of the temperature profile along the filament has a favorable effect in two respects on the reduction in the material transport. Firstly, as a result of the reduction in the axial temperature gradient, there is a marked reduction in the axial transport. Secondly, given an overall identical luminous flux, the maximum temperature in the filament center is slightly lower than in the case of the filament with a constant wire thickness, which has a favorable effect in terms of a reduction in the maximum radial transport. Overall there is a reduction in the maximum material removal occurring, which has a favorable effect in terms of an extension of the life.

Instead of a temperature-controlled deposition reaction, the process which is complementary thereto, namely the temperature-controlled removal of luminous element material, can also be used for producing a luminous element with a modulated diameter. Considered by way of example is the chemical transport reaction

Me<s>+n X<g>=MeXₙ<g>.

In this case, Me is a metallic luminous element material (for example tungsten) and X is a transport medium (for example a halogen). In deposition reactions, the temperature-controlled disintegration of the precursor material

MeXₙ<g>→Me<s>+n X<g>

is used for producing a luminous element with a modulated diameter. In the temperature-controlled material removal reaction, however, the reaction of the transport medium X with the luminous element material Me is used for producing a luminous element with a modulated diameter. If, for example, at a low temperature a precursor consisting of the luminous element material Me and the transport medium X decomposes only slightly in the deposition reaction and therefore the chemical equilibrium is on the side of the precursor material, the reverse results, namely that a relatively large amount of luminous element material is removed when the pure transport medium is passed over a surface of the luminous element material. By way of summary:

Case 1: The equilibrium Me<s>+n X<g>=MeXₙ<g> is on the side of the compound MeXₙ<g> at low temperatures:

Deposition reaction: barely any deposition since MeXₙ<g> barely decomposes

Material removal reaction: large amount of material removed since a large amount of material Me in the form of gaseous MeXₙ is released.

Case 2: The equilibrium Me<s>+n X<g>=MeXₙ<g> is on the side of the compounds Me<s>, X<g> at high temperatures:

Deposition reaction: large amount of deposition since the precursor MeXₙ<g> decomposes to a large extent.

Material removal reaction: barely any material removed since the material Me is barely attacked by the transport medium X.

In both cases, both the deposition reaction and the material removal reaction, luminous elements are obtained whose diameters are smaller at the end than in the filament center, which results in smoothing of the temperature profile along the filament. In the case of the deposition reaction, in this case the luminous element diameter is enlarged in the center; in the case of the material removal reaction, it is reduced at the ends. For both variants the system is self-regulating, i.e. the chemical processes have the effect of smoothing the temperature profile.

Owing to kinetic influences, the suitable temperature ranges for the deposition reaction and the material removal reaction do not necessarily need to correspond. In the case of material removal reactions there is the advantage that the material removal usually takes place relatively evenly; at least in the case of non-recrystallized luminous element material. In the case of recrystallized material, the material removal can take place at a different rate given identical temperatures for different crystal faces or at grain boundaries compared with the crystal faces. In the case of deposition reactions, the growth of crystallites may arise given unfavorable boundary conditions instead of uniform deposition. If, in the case of high concentrations of the precursor, the formation of nuclei occurs already in the gas phase, a deposit of spongy crystallites on the surface is usually observed, but these spongy crystallites can sometimes become a more homogeneous coating at high temperatures. Particularly unfavorable is the growth of acicular dendrites which occurs in some boundary conditions. In most cases, however, reaction conditions can be found in which homogeneous deposition takes place. A preferred method for producing a homogeneous coating consists, for example, in first producing a high nucleus density of the coating material on the surface to be coated. For this purpose, a nucleation step can be introduced before the actual coating process, and this nucleation step is carried out in a different temperature range than the actual coating process, usually at a lower temperature. Even in the case of deposition reactions the use of as yet non-recrystallized wire with a fiber structure originating from the drawing process is preferred since preferred directions defined by the individual crystal faces for crystal growth exist in the case of already recrystallized wire. In many cases, deposition reactions can be controlled more easily as a result of the use of suitable precursors than material removal reactions.

Not only are simple chemical dissociation equilibriums of the type Me<s>+n X<g>=MeXₙ<g> suitable for modulating a luminous element by deposition or material removal reactions, but it is also possible for more complex reactions to be used, for example the reduction of a precursor MeXₙ<g> by means of a reducing agent Y<g> to give Me<s> and a compound YX<g> if (a) a suitable temperature dependence of the chemical reaction rate is present and (b) suitable conditions are found under which uniform deposition and no crystal growth takes place.

A plurality of suitable reaction systems will be described below. Here, details are always only given on the deposition reaction; the variant of the material removal reaction which is complementary thereto is produced correspondingly as described above. The chemistry of these reaction systems is already mostly known; the targeted use thereof for producing a filament with modulated wire thickness or generally a luminous element with a modulated diameter is novel.

(a) Deposition Reactions in Tungsten/Halogen Systems

The basis for carrying out the modulation of the wire thickness are in this case the well-known back-reactions of the halogen cyclic process. First, a lamp with an incandescent filament consisting of tungsten is considered. The rod-shaped lamp, i.e. the to this extent completely constructed, but not yet fused-off lamp with an exhaust tube, has a mixture consisting of an inert gas and tungsten hexafluoride passed through it. Alternatively, the modulation can also be carried out outside of the bulb on the filament by virtue of contact being made with said filament and the mentioned gas mixture being allowed to flow around it. The operating voltage is selected such that the maximum filament temperature is approximately 2700 K. There is then increased deposition of tungsten in the filament center and therefore modulation of the wire thickness. The use of an unprotected bulb consisting of quartz or hard glass is in this case possible without any problems. Although the fluorine which is released during the decomposition of WF₆ reacts at the bulb wall to give SiF₄, this can be accepted since fresh tungsten hexafluoride is supplied continuously from the outside. The formation of an incandescent filament from a wire with a modulated wire thickness results. Advantageous here is the fact that the modulation takes place at temperatures which are only slightly below the operating temperature of the incandescent filament of around approximately 3000 K. If, therefore, a flat temperature profile is set during the modulation at temperatures just below 2700 K, this temperature profile is still very flat even at temperatures of around 3000 K. Alternatively, modulation of the wire thickness can also be carried out by decomposition of tungsten chlorides, bromides, iodides or tungsten oxyfluorides, oxychlorides, oxybromides and oxyiodides. Owing to unavoidable residual traces of oxygen, the tungsten oxyhalides are always present at least in traces, even if pure tungsten halides are used as the precursor. If, for example, tungsten bromides are used, however, the filament needs to be operated in a temperature range of typically below 1700 K. If the wire thickness is modulated such that a flat temperature profile is set at operating temperatures of around or below 1700 K, the temperature profile which is set during operation of this filament at around 3000 K is no longer as flat as that in the case of an operating temperature of around 1700 K owing to the increasing influence of the radiation.

(b) General: Deposition Reactions in Systems Comprising High-Melting Metals and Halogens

The ratios described for an incandescent element consisting of tungsten can also be transferred to luminous elements consisting of other high-melting metals such as tantalum, osmium, rhenium etc. or alloys of these metals. Owing to the operation of the incandescent element in a flow of a gas mixture consisting of an inert gas and the respective metal halides, modulation of the diameter of the luminous element can be achieved. The chemistry of these important chemical transport reactions is described in many cases in H. Schäfer, “Chemische Transportreaktionen” [Chemical transport reactions], Verlag Chemie, 1962. It is important that the temperature of the luminous element is matched during the deposition to the requirements of the respective chemical reaction systems. Preferably, the fluorides of the respective metals are again used since they decompose only at high temperatures, which usually come very close to the operating temperatures of the luminous element.

(c) Deposition of Tungsten, Molybdenum etc. by Reduction of the Metal Fluorides by Hydrogen

Tungsten hexafluoride is reduced by hydrogen to give tungsten, with HF being produced. In the simplest case, the chemical reaction can be described by

WF₆<g>+3 H₂−>W<s>6 HF.

At least in the temperature range between approximately 400° C. and 1000° C., this chemical reaction proceeds more quickly the higher the temperature is. The deposition rate and the consistency of the depositions (undesired growth of dendrites or desired homogeneous deposition) are influenced, apart from by the temperature, by the ratio of the partial pressures of WF₆ and H₂ and the total pressure. For details relating to this and related reaction systems, see also, for example, Jean F. Berkeley, Abner Brenner, Walter E. Reid, “Vapor Deposition of Tungsten by Hydrogen Reduction of Tungsten Hexafluoride”, J. Electrochem. Soc., 114 (1967) 6, pages 561-568, and A. M. Schroff, G. Deival, “Recent developments in the chemical vapor deposition of tungsten and molybdenum”, High Temperatures—High Pressures, 1971, volume 3, pages 695-712.

(d) Deposition Reactions in the Carbon/Halogen, Carbon/Hydrogen and Carbon/Sulfur Systems

A further example is considered to be an incandescent element consisting of a carbon fiber or a bundle of carbon fibers. In this case, modulation of the thickness of the fibers can be achieved similarly by virtue of the luminous element being operated at temperatures in the range between 2800 K and 3500 K, preferably between 3000 K and 3500 K, in a mixture of an inert gas (for example a noble gas) and carbon tetrafluoride CF₄. Other carbon/halogen or else carbon/hydrogen compounds decompose already at temperatures far below 1000 K. Modulation using these systems is possible, but is less advantageous as a result of the deposition temperatures which are far below the operating temperature. For details on the chemistry of the carbon/halogen or carbon/hydrogen systems, see, for example, “Kohlefadenlampen mit einem chemischen Transport-zyklus” [Carbon filament lamps with a chemical transport cycle], Philips techn. Rdsch. 35, 338-241, 1975/76, No. 11/12 and W. J. van den Hoek, W. Klessens, “Carbon-hydrogen and carbon-chlorine transport reactions in carbon filament incandescent lamps”, Carbon 13, 429-432 (1975). During operation of the luminous element just below the melting point of the carbon, the use of the C/S system is also possible. If sulfur carbon CS₂ is passed over carbon at temperatures of above approximately 2200 K, CS is produced, which decomposes in the range between 3400 K and approximately 4000 K with the release of carbon.

(e) Luminous Elements Consisting of Metal Carbides, Nitrides or Borides: Modulation of the Cross Section of the Incandescent Element Consisting of the Starting Metal by Means of Deposition Reactions

Luminous elements consisting of metal carbides, nitrides or borides or alloys of these compounds are usually produced by carburization, nitridization or boronation of the luminous elements from the respective starting metals, since metal carbides, nitrides or borides to be considered as ceramics are too brittle for them to be easily processed. There is thus the possibility of modulating the diameters of the luminous elements consisting of the respective starting metals and then, in the next process step, of carrying out the carburization or nitridization or boronation. A lamp comprising an incandescent filament consisting of tantalum carbide is considered as an example below. In this case, the incandescent filament can first be wound from tantalum. If, for example, the region to be modulated of the tantalum filament is operated at temperatures of between 2800 K and 3200 K in a flow of an inert gas and tantalum fluoride, an incandescent filament consisting of tantalum with a modulated wire thickness is obtained, in the case of which the wire diameter is greater in the center than close to the filament ends. Then, the filament consisting of tantalum is converted into tantalum carbide by carburization in an atmosphere consisting of an inert gas and a hydrocarbon, cf., for example, S. Okoli, R. Haubner, B. Lux, Surface and Coatings Technology 47 (1991), 585-599, and G. Hörz, Metall 27, (1973), 680. The modulation of the wire thickness in this case is maintained, i.e. the relative fluctuations in the diameter of the filament consisting of tantalum are reproduced precisely on the filament consisting of tantalum carbide. Alternatively, tantalum can also be deposited on an incandescent element consisting of tantalum carbide, and the tantalum layer can be carburized in the next process step.

(f) Luminous Elements Consisting of Metal Carbides, Nitrides or Borides: Modulation of the Wire Thickness of the Incandescent Element by Direct Deposition of the Carbides, Nitrides and Borides

It is also possible for the metal carbides, metal nitrides and metal borides to be deposited directly on the respective luminous elements. For example, tantalum carbide can be deposited directly on luminous elements consisting of tantalum carbide. The fundamental properties of this process are described, for example, in W. J. Heffernan, I. Ahmad, R. W. Haskell, Benet Weapons Laboratory, Watervliet, N.Y., USA, “A continuous CVD process for coating filaments with tantalum carbide”, Chem. Vap. Deposition, Int. Conf., 4th Meeting (1973), Meeting Date 1973, pages 498-508; therein, the dependencies of the deposition rates on the individual experimental parameters are discussed in detail. The total process for the deposition of tantalum carbide can be described by the summarizing reaction equation TaCl₅+CH₄+½ H₂→TaC+5 HCl. Under suitable reaction conditions, deposition rates of TaC of the order of magnitude of 10 μm/min are obtained, i.e. these deposition rates are in a range which allows the possible use of the process in a mechanized production process. The deposition rates of TaC change considerably in the temperature range between approximately 1100 K and 1300 K; i.e. the operating voltage at the TaC luminous element should be set such that the temperatures fluctuate in the range of the temperature profile to be smoothed between 1100 K and 1300 K. It is furthermore essential that layers grow relatively symmetrically under the given reaction conditions and not, for example, crystallites, which in practice do not make a contribution to flow transport. Similar chemical reaction systems exist for the other metal carbides, nitrides and borides or alloys of these individual components.

The modulation of the wire thickness is carried out for such a period of time until such a modulation of the radii has been achieved that leads to an optimum or virtually optimum temperature profile during lamp operation, see further above. If the period of time for the deposition or material removal process is too short, the modulation is insufficient, and the luminous element burns through usually close to the center. If the period of time for the deposition or material removal process is too long, although relatively homogeneous temperature distributions are achieved in the coil, for this there is a relatively large amount of material removal at the filament ends at the beginning of the sudden temperature drop. In the case of deposition times which are too long, there is the risk of a turn-to-turn fault or electrical flashover in the case of filaments with a small pitch. Since, in addition, process-related influences, for example a possibly slightly uneven flow around the filament, are relevant, it is recommended to determine the optimum deposition time by way of experiments. For this purpose, material removal or material deposition is carried out at the filaments for various times, then completely constructed, filled lamps of otherwise identical geometry are photometrically measured using these filaments and tested by means of the life test. The optimum is the greatest lamp quality, i.e. the lamps which achieve the longest life given the same luminous efficiency.

The embodiments described here are not restricted to coil-shaped incandescent elements consisting of wires. They are relevant for virtually all luminous elements in which the generation of light is based on the principle of the generation of temperature radiation. Examples of luminous elements of other geometries are straight or wound strips, planar slotted metal foils with meandering line profiles or a rectangular line cross section, helical luminous elements, etc.

If appropriate, the possibilities described here for smoothing the temperature profile along the filament can be combined with further measures, for example the use of a filament with a modulated pitch.

The procedure described here provides considerable advantages over the electrolytic removal of material from filaments described in DD 217 084 A1. Firstly, a self-regulating system is used here, i.e. the temperature itself controls the material removal and deposition processes. Secondly, chemical deposition and material removal reactions can be realized substantially more easily than wet-chemical processes as in DD 217 084 A1 in terms of process technology in mass production. Finally, the electrolytic removal of material as described in DD 217 084 A1 is restricted to luminous elements consisting of selected metallic materials and cannot be applied to luminous elements consisting of ceramics (for example metal carbides).

The processes described here likewise provide considerable advantages over the procedure described in J. Schröder, “Profilierung von Wolframwendeln in Glühlampen durch chemische Transportreaktionen” [Profiling of tungsten filaments in incandescent lamps by means of chemical transport reactions], Philips techn. Rdsch. 35, 354-355 (1975/76). In contrast to Philips techn. Rdsch. 35, 354-355 (1975/76), in this case the luminous element material is not moved from colder to hotter points, but either luminous element material which is supplied exclusively from the outside is deposited or exclusively luminous element material is removed and taken away in the form of volatile gaseous compounds. That is to say that in this case luminous element material which is supplied from the outside is deposited or luminous element material is removed and taken away completely, while, in Philips Techn. Rdsch. 35, 354-355 (1975/76), only the pure transport medium (for example a halogen) is supplied and the luminous element material is redeposited. The procedure described here provides the following advantages over the simple redeposition of luminous element material as described in Philips techn. Rdsch. 35, 354-355 (1975/76):
During the redeposition process, the material removed at a colder point is preferably deposited at the directly adjacent hotter points at which the molecule bearing the luminous element material decomposes, while less material is deposited at points of the same high temperature which are further away, since now only “fewer molecules bearing the material arrive”. If, in accordance with the procedure described here, material is deposited by the operation of the filament in a flow of a suitable precursor material or luminous element material is removed, smoothed temperature profiles are obtained to a greater degree.
When using pure deposition or material removal reactions, the reaction conditions can be optimized substantially more easily as regards achieving a uniform diameter variation, for example by suitable nucleation steps being introduced in advance in the deposition processes and by the selection of suitable concentrations and throughflow rates. In the case of the redeposition processes, there are considerably fewer parameters available for optimization purposes. The concentration of the material to be deposited during the deposition process is fixed, for example, largely by the chemical reaction system; the partial pressure of the compound bearing the material to be deposited can be substantially influenced only by the concentration of the transport medium.
In the case of luminous elements consisting of ceramics such as metal carbides, redeposition reactions as in Philips techn. Rdsch. 35, 354-355 (1975/76) cannot be applied since at least two chemical elements need to be transported. For example, when using luminous elements consisting of tantalum carbide, both tantalum and the carbon would need to be redeposited. For this purpose, the temperature dependencies of the chemical equilibriums between tantalum and the transport medium, on the one hand, and carbon and the transport medium, on the other hand, would need to be precisely the same. That is to say that tantalum and carbon would have to be dissolved in the gas phase to precisely the same extent by the transport medium at relatively cold points; while, in the case of relatively high temperatures, the degree of dissociation of the compounds bearing the tantalum and the carbon would have to be the same. Such chemical reaction systems do not exist, however; it is merely possible to approximate the ideal state. In addition, the transport rates of the two elements to be transported are different; thus, for example carbon/fluorine compounds diffuse significantly more quickly than tantalum/fluorine compounds.

### BRIEF DESCRIPTION OF THE DRAWINGS

The invention will be explained in more detail below with reference to an exemplary embodiment. In the figures:

FIG. 1 shows an incandescent lamp with a carbide luminous element in accordance with an exemplary embodiment;

FIG. 2 shows a coiled luminous element for the incandescent lamp shown in FIG. 1;

FIG. 3 shows a graph showing the change in the radius of the luminous element as a the function of the distance from the filament center;

FIG. 4 shows a comparison of the temperature at the luminous element during the deposition as a function of the distance from the filament center;

FIG. 5 shows a comparison of the temperature at the luminous element during operation as a function of the distance from the filament center.

### PREFERRED EMBODIMENT OF THE INVENTION

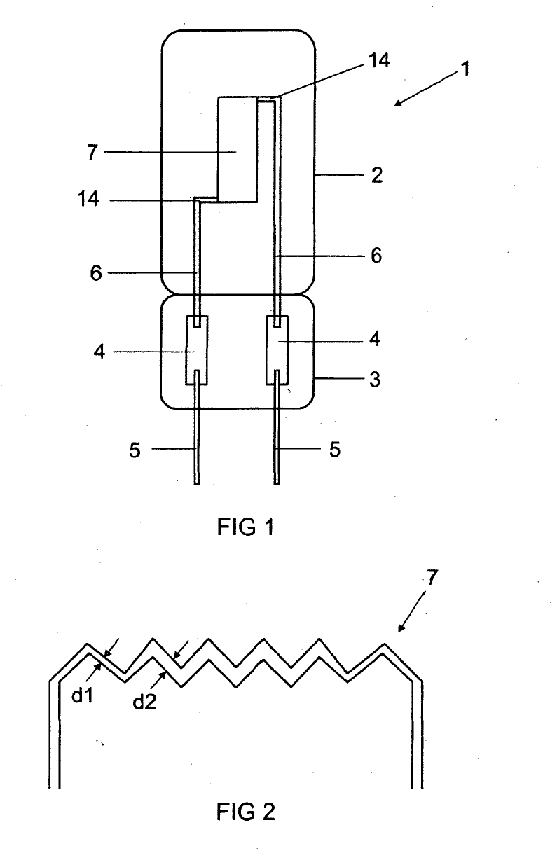

FIG. 1 shows an incandescent lamp 1 with a pinch seal at one end and with a bulb consisting of quartz glass 2, a pinch seal 3, and inner power supply lines 6, which connect the foils 4 in the pinch seal 3 to a luminous element 7. The luminous element is a singly-coiled, axially-arranged wire consisting of TaC, whose uncoiled ends 14 are passed on transversely with respect to the lamp axis. The outer feed lines 5 are attached to the foils 4 on the outside. The inner diameter of the bulb is 5 mm. The filament ends 14 are then bent parallel to the lamp axis and form the inner power supply lines 6 there as an integral extension. The power supply lines 6 can also be separate parts.

The incandescent filament consisting of tantalum carbide in the lamp illustrated schematically in FIG. 1, whose fundamental design largely corresponds to a low-voltage incandescent halogen lamp available on the market, is produced by means of the carburization of a filament (12 turns, pitch factor 2.24, core factor 5.6) coiled from tantalum wire (diameter 135 μm). The length of an outgoing section is 10 mm. During the carburization, the wire diameter increases to 146 pin. When using xenon as the carrier gas, to which substances containing hydrogen, nitrogen, hydrocarbon and halogen (J, Br, Cl, F) are also added, the lamp has a power consumption of approximately 45 W during operation on 14 V, the color temperature characteristically being around 3300 K.

FIG. 2 shows a more precise schematic illustration of the luminous element 7 once the modulation of the wire cross section has been carried out by the deposition process described further below. The diameter of the wire of the luminous element is different. In the center, the diameter d2 is markedly greater than at the edge, where the diameter is denoted by d1.

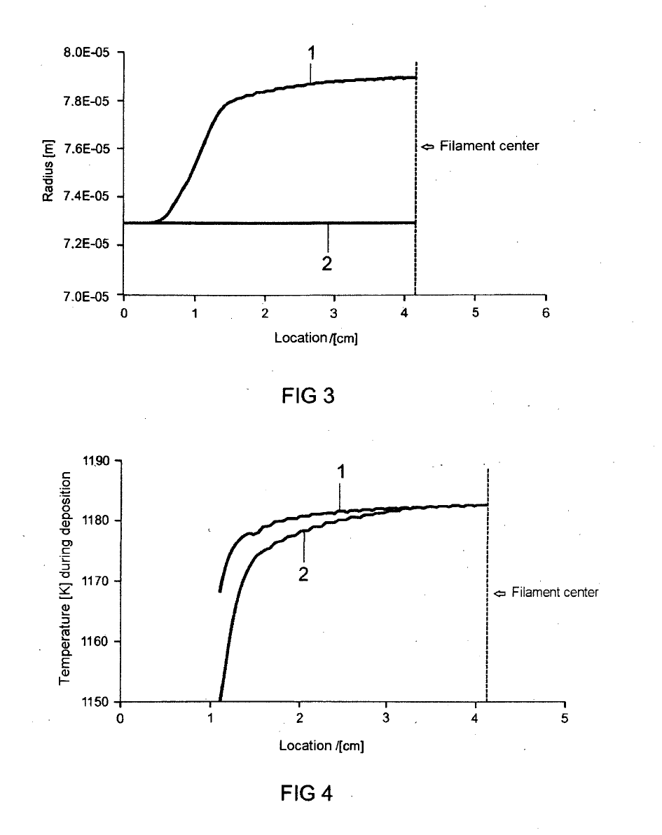

FIG. 3 shows the profile of the radius of the filament wire after deposition for one minute corresponding to the reaction equation

TaCl₅+CH₄+½ H₂→TaC+5 HCl.

The deposition conditions were selected for example as described in (e) (HCl flows over tantalum to produce TaCl₅, gas flows 40 cm³/min of HCl, 250 cm³/min of CH₄). Since the radius of the wire changes symmetrically in relation to the filament center, the illustration only shows the radius of the wire for one half. The other half is mirror-symmetrical. The specified location denotes the position along the luminous wire.

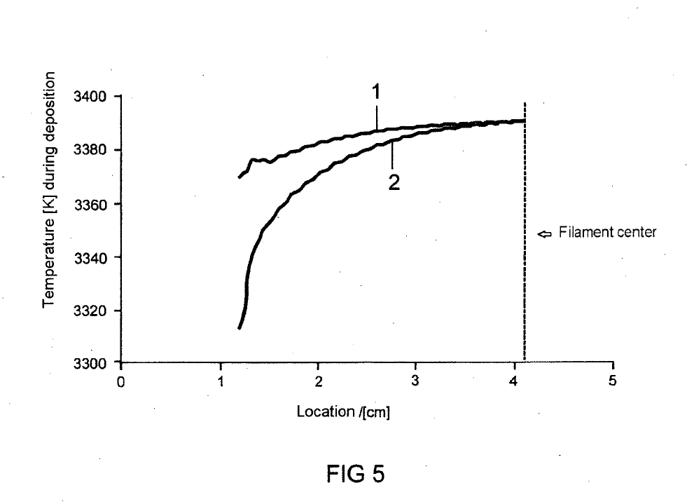

FIG. 4 shows a comparison of the temperature which is used in the deposition process between a coiled luminous element with changing wire thickness (curve 1) and an identical luminous element with a constant wire thickness (curve 2) for the exemplary embodiment described here. In this case, the coiled luminous elements are in a typical temperature range suitable for the deposition of TaC. For the purpose of improved comparability, the operating voltage was matched such that the temperatures in the center of the luminous element correspond.

FIG. 5 shows a comparison of the temperature during operation between a coiled luminous element with changing wire thickness (curve 1) and an identical luminous element with a constant wire thickness (curve 2) for the exemplary embodiment. In this case, the coiled luminous elements are in a typical temperature range achieved during lamp operation. For the purpose of improved comparability, the operating voltage was also matched in this case such that the temperatures in the center of the luminous element correspond.

If the outgoing filament sections are produced integrally with the luminous element from a continuous wire, as in the exemplary embodiment in FIG. 1, and if a deposition process is selected for the modulation of the wire thickness, in the case of a considerable enlargement of the luminous wire diameter in the region of the coil it can arise that the wire sections which have not been enlarged and are therefore markedly thinner are subjected to a relatively high load at the outgoing filament sections close to the pinch seal when the lamp is switched on. In this case, the use of coated filaments as described in DE-Az 10 2004 014 211.4 is an option for increasing the make-proofness.

In addition it should also be mentioned that modulation of the diameter of the luminous element can also take place by means of material removal by means of lasers. In addition, modulation of the wire diameter can also take place by applying material by means of sputtering processes or by means of electrolytic deposition (in contrast to electrolytic material removal as described in DD 217 084 A1). These and other processes are technically more difficult to control, however, since they do not function in self-regulating fashion.

In the case of planar incandescent filaments with a rectangular cross section, the distance between the meandering slots can be varied, for example.

1. A luminous element for an incandescent lamp consisting of a metal or a metal compound, characterized in that the cross section of the luminous element increases continuously from the edge of the luminous element toward the center of the luminous element, the variation in the cross section of the luminous element having been performed by means of chemical deposition or material removal processes, and the cross section being in particular circular.

2. The luminous element as claimed in claim 1, characterized in that the cross section increases by at least 15%.

3. The luminous element as claimed in claim 1, characterized in that the luminous element consists of tantalum carbide, hafnium carbide, zirconium carbide or other metal carbides or the respective nitrides or borides.

4. The luminous element as claimed in claim 1, characterized in that the luminous element consists of an alloy of various metal carbides, metal nitrides or metal borides.

5. An incandescent lamp with a luminous element as claimed in one of the preceding claims and with power supply lines, which hold the luminous element, the luminous element being introduced together with a fill in a vacuum-tight manner in a bulb.

6. A process for the manufacture of a luminous element as claimed in claim 1, characterized in that the variation in the cross section of the luminous element is produced by the thermal decomposition of a precursor bearing the luminous element material by means of a deposition process, the luminous element being operated during this deposition in such a temperature range which is matched to the chemical reaction system that more luminous element material is deposited, as a result of the decomposition of the precursor, at the individual points on the luminous element the higher the temperature is at the relevant points.

7. A process for the manufacture of a luminous element as claimed in claim 1, characterized in that the variation in the cross section of the luminous element is produced by the removal of luminous element material by reaction with a transport medium, the luminous element being operated during this material removal process in such a temperature range which is matched to the chemical reaction system that more luminous element material is removed at the individual points on the luminous element the lower the temperature is at the relevant points.

8. The process for the manufacture of a luminous element as claimed in claim 6, characterized in that the variation in the cross section of the luminous element consisting of tungsten or tungsten alloys is carried out by the thermal decomposition of tungsten halides, tungsten oxyhalides, tungsten carbonyls or tungsten cyanides, the luminous element being operated, during the deposition, in such a temperature range that more tungsten is deposited the higher the temperature of the luminous element is at the relevant point.

9. The process for the manufacture of a luminous element as claimed in claim 6, characterized in that the variation in the cross section of the luminous element, which consists of a high-melting metal such as, for example, osmium, rhenium, niobium, hafnium, zirconium or tantalum or alloys of these metals, is carried out by thermal decomposition of metal halides (metal fluorides, chlorides, bromides, iodides), metaloxyhalides, metal carbonyls or metal cyanides, the luminous element being operated, during the deposition, in such a temperature range that more metal is deposited the higher the temperature of the luminous element is at the relevant point.

10. The process for the manufacture of a luminous element as claimed in claim 6, characterized in that the metal deposited for the purpose of varying the cross section is produced by reducing the metal halides or metaloxyhalides using hydrogen, the luminous element being operated, during the deposition, in such a temperature range that more metal is deposited the higher the temperature of the luminous element is at the relevant point.

11. The process for the manufacture of a luminous element as claimed in claim 6, characterized in that the variation in the cross section of the luminous element, which consists of a carbon fiber or a bundle of carbon fibers, is carried out by thermal decomposition of carbon/halogen, carbon/hydrogen or carbon/sulfur compounds, the luminous element being operated, during the deposition, in such a temperature range that more carbon is deposited the higher the temperature of the luminous element is at the relevant point.

12. The process for the manufacture of a luminous element as claimed in claim 6, characterized in that, in order to manufacture a luminous element from metal carbide, nitride or boride or an alloy of the various metal carbides, nitrides and borides, the cross section modulation is carried out by deposition of the luminous element material used on the luminous element in a CVD process, the luminous element being operated, during the deposition, in such a temperature range that more luminous element material is deposited the higher the temperature of the luminous element is at the relevant point.

13. The process for the manufacture of a luminous element as claimed in claim 6, characterized in that, in order to manufacture a luminous element from tantalum carbide, the variation in the cross section of the luminous element is carried out by deposition of tantalum carbide by the use of the reaction between tantalum halides or tantalum oxyhalides, preferably tantalum chloride, methane and hydrogen, the luminous element being operated, during the deposition, in such a temperature range that more luminous element material is deposited the higher the temperature of the luminous element is at the relevant point.

14. The process for the manufacture of a luminous element as claimed in claim 7, characterized in that, in order to produce a luminous element from one of the metals tungsten, osmium, rhenium, tantalum, niobium, zirconium or hafnium, the variation in the cross section for smoothing the temperature profile is carried out by the removal of metal by means of halogens, pseudohalogens, oxygen or compounds thereof for example with hydrogen, the luminous element being operated, during the material removal process, in such a temperature range that more material is removed the lower the temperature is.

15. The process for the manufacture of a luminous element as claimed in claim 7, characterized in that, in order to manufacture a luminous element from carbon, the variation in the cross section for smoothing the temperature profile is carried out by removal of carbon by means of halogens, hydrogen, sulfur or compounds thereof, the luminous element being operated, during the material removal process, in such a temperature range that more material is removed the lower the temperature is.

16. The process for manufacture of a luminous element as claimed in claim 7, characterized in that the variation in the cross section for smoothing the temperature profile is carried out by a reaction of the metal carbide with a hydrogen halide, the luminous element being operated, during the material removal process, in such a temperature range that more material is removed the lower the temperature is.

17. The process for the manufacture of a luminous element as claimed in claim 6 or 7, characterized in that, in order to manufacture a luminous element from metal carbide, nitride or boride or an alloy of various metal carbides, nitrides and borides, first the cross section of the luminous element, which consists of the starting metal, as claimed in one of the preceding claims is modulated either by deposition or material removal reactions in order to level off the temperature gradient, and then the metal is converted into the desired luminous element material by means of carburization, nitridization or boronation.

18. The process for the manufacture of a luminous element as claimed in claim 6 or 7, characterized in that the luminous element is in the form of a sheet-metal strip or in the form of another planar filament with a rectangular cross section.

19. The process for the manufacture of a luminous element as claimed in claim 6 or 7, characterized in that the luminous element is a wrapped wire.
